(19) United States
(12) Patent Application Publication
(10) Pub. No.: US 2002/0105938 A1
(43) Pub. Date: Aug. 8, 2002

(54) Time division data transmitter/receiver capable of specifying need or non-need for retransmission of data packet as appropriate

(75) Inventor: Katsuji Suzuki, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 10/068,265

(22) Filed: Feb. 5, 2002

(30) Foreign Application Priority Data
Feb. 7, 2001 (JP) 2001-031174

(51) Int. Cl. H04B 7/212; H04J 3/24

(52) U.S. Cl. 370/347; 370/349

(57) ABSTRACT

A time division data transmitter/receiver for transmitting/receiving data packets by a TDMA/TDD communication system, having a transmitting/receiving unit for transmitting/receiving high frequency signals, a modulating/demodulating unit for converting the high frequency signals into baseband signals, and a baseband signal processing unit for processing the baseband signals, wherein each of the data packets is augmented with a frame flag for specifying the data packet and a retry flag for specifying, in the event the data packet suffers a communication error, the need or non-need to retransmit the data packet, and wherein the baseband signal processing unit is provided with a means for changing over, where the retry flag of one data packet is transmitted with the need to retransmit specified, to an operation mode to retransmit the packet only when the frame flag specification of the data packet received immediately after that transmission is wrong or when a reception error has arisen in that received data packet.

### BACKGROUND OF THE INVENTION

1. Field of the Invention

The present invention relates to a time division data transmitter/receiver, and more particularly to a time division data transmitter/receiver capable, when a data packet is to be transmitted or received by a time division multiple access/time division duplex (TDMA/TDD) communication system, of specifying as appropriate the need or non-need for retransmission of a data packet having suffered any communication error.

2. Description of the Prior Art

Usually, in a playing device such as a game machine, data is transmitted and received in a data packet form by a time division multiple access/time division duplex (TDMA/TDD) system using wireless signals between a playing device per se (master device) and a pad wireless controller (slave device) held by the player. When the playing device is used, the data transmitted and received between the playing device per se and the pad wireless controller constitutes contents matching a form of control preferred by the player for controlling the playing device per se, and accordingly the data length is often variable.

Incidentally, a time division data transmitter/receiver for use in such a playing device per se or pad wireless controller is provided with a transmission/reception switching unit, a high frequency signal transmitting/receiving unit for transmitting/receiving high frequency signals, a modulating/demodulating unit for alternate frequency modulation of high frequency signals and baseband signals, a baseband signal processing unit for processing baseband signals, an operating unit to be used by the player for input operations, and a control unit for exercising general control over these units.

FIG. 5 is a block diagram illustrating an example of configuration of a known time division data transmitter/receiver.

As shown in FIG. 5, a time division data transmitter/receiver 50 has an antenna 51, a transmission/reception switching unit 52 consisting of a change-over switch, a high frequency signal (RF) transmitting/receiving unit 53 having a high frequency signal (RF) transmitting unit 53₁, and a high frequency signal (RF) receiving unit 53₂, a modulating/demodulating unit (MODEM) 54 having a modulating circuit (MOD) 54₁ for converting baseband signals into high frequency signals and a demodulating circuit (DEM) 54₂ for converting high frequency signals into baseband signals, a baseband signal processing unit 55 for processing baseband signals, an operating unit 56, and a control unit (CPU) 57 consisting of a microcomputer or the like.

Of the transmission/reception switching unit 52, the common terminal is connected to the antenna 51; one of the selective terminals, connected to the output terminal of the high frequency signal transmitting unit 53₁; the other selective terminal is connected to the input terminal of the high frequency signal receiving unit 53₂; and the control terminal, to the control unit 57. Of the modulating circuit 54₁, the input terminal is connected to the output terminal of the baseband signal processing unit 55, and the output terminal, to the input terminal of the high frequency signal transmitting unit 53₁. Of the modulating circuit 54₂ the input terminal is connect to the output terminal of the high frequency signal receiving unit 53₂, and the output terminal, to the input terminal of the baseband signal processing unit 55. The baseband signal processing unit 55 is connected to the control unit 57, and the operating unit 56, to the control unit 57.

In this case, the format of data packets used in data transmission by the time division data transmitter/receiver 50 has at the beginning a preamble area for transmitting a preamble code, followed by an ID area for transmitting an identification (ID) code, further by a data length area for transmitting the number of bytes of data to be prescribed in the further following data area, further by a data area for transmitting the data, and finally by a CRC area for transmitting a cyclic redundancy check (CRC) code. In this data packet, the preamble area, the ID area and the data length area constitute a header.

Next, FIG. 6 illustrates one example of transmission/reception timings used when transmit/receive data are transmitted or received by the time division data transmitter/receiver 50 shown in FIG. 5.

In FIG. 6, Tx represents transmit data (data packet) transmitted by the time division data transmitter/receiver 50, and Rx, receive data (data packet) received by the time division data transmitter/receiver 50.

The operation of the time division data transmitter/receiver 50 having the configuration described above will be described below with reference to FIG. 5 and FIG. 6.

Data transmission between a playing device per se and a pad wireless controller using the time division data transmitter/receiver 50, as shown in FIG. 6, is set so that the transmission timing of the transmit data Tx and the reception timing of the receive data Rx come alternately on a time division basis.

In this case, as the operations of the time division data transmitter/receiver 50 on the playing device per se side and of the time division data transmitter/receiver 50 on the pad wireless controller are basically the same, the following description will mainly refer to the time division data transmitter/receiver 50 on the pad wireless controller side.

In the time division data transmitter/receiver 50, when a data transmission timing comes, the control unit 57 instructs the baseband signal processing unit 55 to form transmit data, and sets the transmission/reception switching unit 52 to the high frequency signal transmitting unit 53₁ side. At this time, the baseband signal processing unit 55 composes, as described above, a data packet by adding a preamble code, an ID code, a data length code and a CRC code to the data to be transmitted, and supplies the data packet to the modulating circuit 54₁. The modulating circuit 54₁ modulates the data of the supplied data packet into a transmit high frequency signal, and supplies it to the high frequency signal transmitting unit 53₁. The high frequency signal transmitting unit 53₁ subjects to power amplification the supplied transmit high frequency signal to a transmittable level, supplies the amplified signal to the antenna 51 via the transmission/reception switching unit 52, which is already changed over, and transmits it as a wireless signal to the time division data transmitter/receiver 50 on the playing device per se side. This transmission of transmit data takes place within a transmission timing range illustrated in FIG. 6.

On the other hand, in the time division data transmitter/receiver 50, when a data reception timing comes, the control unit 57 instructs the baseband signal processing unit 55 to process receive data, and switches the transmission/reception switching unit 52 to the high frequency signal receiving unit 53₂ side. At this time, if a wireless signal containing the data transmitted by the time division data transmitter/receiver 50 on the playing device per se side arrives at the antenna 51, the high frequency signal receiving unit 53₂ receives it as a receive high frequency signal from the antenna 51 via the already switched transmission/reception switching unit 52, amplifies the high frequency signal to a prescribed level, and supplies the amplified signal to the demodulating circuit 54₂. The demodulating circuit 54₂ demodulates the supplied receive high frequency signal into a baseband signal, and forms a data packet. This data packet is supplied to the baseband signal processing unit 55 and, after being checked by the baseband signal processing unit 55 as to whether or not it constitutes legitimate receive data Rx, undergoes data extraction, and the extracted data is supplied to the control unit 57 and other units.

At every subsequent timing of data transmission, the same processing as what took place at the transmission timing referred to above is executed in the time division data transmitter/receiver 50, followed by the repeated execution of data reception and data transmission as long as there is transmit data.

Incidentally, since the time division data transmitter/receiver 50 on the playing device per se side and the time division data transmitter/receiver 50 on the pad wireless controller side have to transmit and receive data within each transmission timing range and reception timing range, respectively, it is necessary to synchronize the data of the two time division data transmitter/receivers 50.

Usually, the synchronization of data transmitting/receiving operations of such time division data transmitter/receivers 50 is accomplished by synchronizing the transmitting/receiving operations of the time division data transmitter/receiver 50 on the pad wireless controller side with those of the time division data transmitter/receiver 50 on the playing device per se side on the basis of a frame synchronization signal added to the transmit data. Upon achievement of synchronization between the time division data transmitter/receiver 50 on the pad wireless controller side and the time division data transmitter/receiver 50 on the playing device per se side, a link is established between the two time division data transmitter/receivers 50.

Apart from this, when data is to be transmitted/received between the time division data transmitter/receiver 50 on the playing device per se side and the time division data transmitter/receiver 50 on the pad wireless controller side, if data transmitted within a timing range wholly or partly fails to be received by the time division data transmitter/receiver 50 on the other side for any reason, a communication error may arise. In such an event, if the data suffering the communication error, such as button manipulation data or the like, the error can be made up for by transmitting another set of button manipulation data at the next transmission timing, but if the affected data is vital such as control data for a specific part, the absence of the data would seriously affect subsequent control actions.

To avoid such a consequence, for known time division data transmitter/receivers 50, it is prescribed that, if a link is established between the two time division data transmitter/receivers 50 and a communication error arises between the two time division data transmitter/receivers 50, the two time division data transmitter/receivers 50 should be set in either a first operation mode (operation mode needing retransmission) for retransmitting the data packet having suffered the communication error or a second operation mode (operation mode needing no retransmission) for transmitting a new data packet on every such occasion without retransmitting the data packet having suffered the communication error.

Whereas the above-described known time division data transmitter/receivers 50 are so disposed that, when a link is established between the two time division data transmitter/receivers 50, the two time division data transmitter/receivers 50 are set in either the first operation mode (operation mode needing retransmission) for retransmitting the data packet having suffered the communication error or the second operation mode (operation mode needing no retransmission) for transmitting a new data packet on every such occasion without retransmitting the data packet having suffered the communication error, once the two time division data transmitter/receivers 50 are set in either the first or the second operation mode, that mode will be maintained unless the arrangement for the operating mode of the two time division data transmitter/receivers 50 is changed.

Thus, if the two time division data transmitter/receivers 50 are set in the first operation mode, while there will be the advantage that, where important data to be transmitted are lost on the way, the lost important data are retransmitted and the complete loss of the important data can be avoided, there will also be the disadvantage that the retransmission of unimportant data lost on the way would take extra time in data exchange and a delay may arise in control actions. On the other hand, if the two time division data transmitter/receivers 50 are set in the second operation mode, while there will be the advantage that, where the skipping of retransmission of lost data would ensure rapid execution of control actions, there will also be the disadvantage that a wrong control action may be executed in time of loss of important data, because the lost important data are not transmitted to the time division data transmitter/receiver 50 on the other side.

### SUMMARY OF THE INVENTION

An object of the present invention, attempted in view of such a technical background, is to provide a time division data transmitter/receiver enabled to avoid delays in control actions and execution of wrong control actions by appropriately changing the operation mode according to the content of the data to be transmitted.

In order to achieve the object mentioned above, according to the invention, there is provided a time division data transmitter/receiver for transmitting/receiving data packets by a time division multiple access/time division duplex communication system, having at least a transmitting/receiving unit for transmitting/receiving high frequency signals, a modulating/demodulating unit for converting the high frequency signals into baseband signals, and a baseband signal processing unit for processing the baseband signals, wherein in each of the data packets is additionally set a one-bit frame flag for specifying the data packet and a one-bit retry flag for specifying, in the event the data packet suffers a communication error, the need or non-need to retransmit the data packet; and the baseband signal processing unit is provided with a means for changing over, where the retry flag of one data packet is transmitted with the need to retransmit specified, to an operation mode to retransmit the data packet only when the frame flag specification of the data packet received immediately after that transmission is wrong or when a reception error has arisen in that received data packet.

The aforementioned means, by specifying the retry flag to a bit value 1 indicating the need for retransmission or to a bit value 0 indicating the non-need for retransmission according to the relative importance of data contained in the data packet to be transmitted, ensures transmission of data greater in relative importance by retransmitting them if their initial transmission fails, so that the pertinent prescribed control action can be executed without fail, refrains from retransmission of relatively unimportant data even if their initial transmission fails, and instead transmits the next data so that various control actions can be executed without delay.

As an appropriate example of the aforementioned means, the retry flag sets a bit value 1 when the data packet needs retransmission or a bit value 0 when the data packet needs no retransmission, and the frame flag, where two data packets needing retransmission to be transmitted consecutively are specified, specifies one of the data packets at a bit value 0 and the other data packet at a bit value 1.

Such a configuration can not only facilitate setting of the retry flag and the frame flag but also enables the information contents of the retry flag and the frame flag to be clearly expressed.

### BRIEF DESCRIPTION OF THE DRAWINGS

FIG. 1, illustrating a time division data transmitter/receiver embodying one aspect of the present invention, is a block diagram of the configuration of essential parts of its baseband signal processing unit.

FIG. 2 illustrates an example of format of data packets used in the transmission of data by the time division data transmitter/receiver illustrated in FIG. 1.

FIG. 3 consists of truth tables showing basic actions by the time division data transmitter/receiver illustrated in FIG. 1.

FIG. 4 illustrates an example of form of data transmission/reception taking place between the time division data transmitter/receiver shown in FIG. 1 and a time division data transmitter/receiver on the other side.

FIG. 5 is a block diagram showing an example of configuration of a known time division data transmitter/receiver.

FIG. 6 illustrates one example of transmission/reception timings used when transmit/receive data is transmitted or received by the time division data transmitter/receiver shown in FIG. 5.

### DESCRIPTION OF THE PREFERRED EMBODIMENT

A preferred embodiment of the present invention will be described below with reference to accompanying drawings.

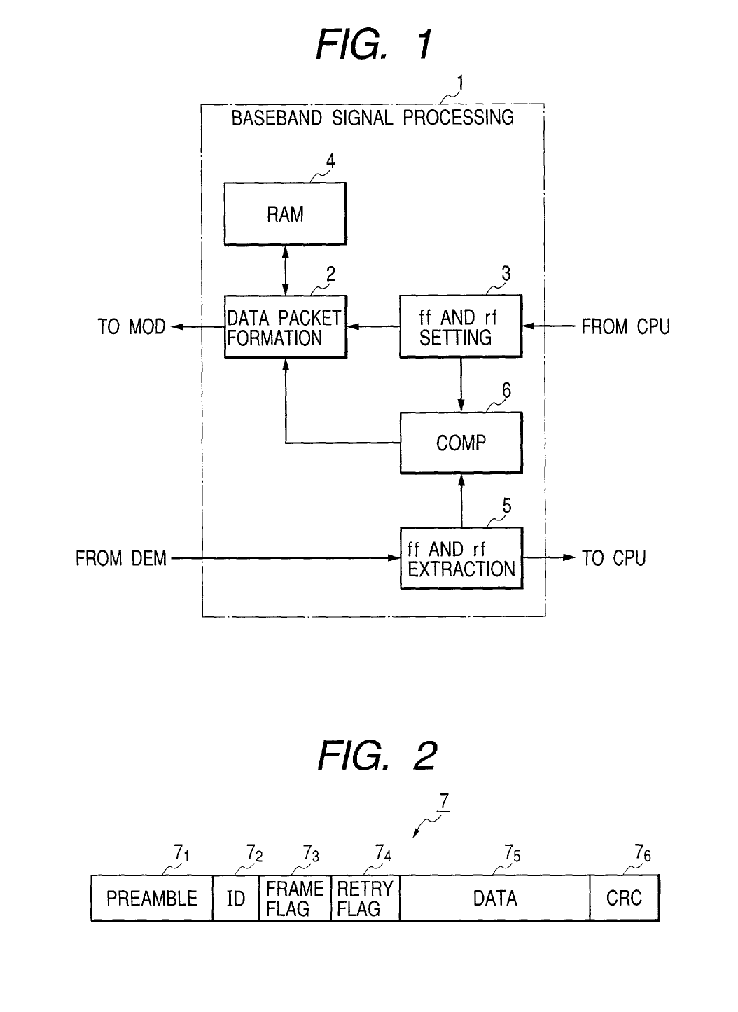

FIG. 1, illustrating a time division data transmitter/receiver embodying one aspect of the present, is a block diagram of the configuration of essential parts of its baseband signal processing unit.

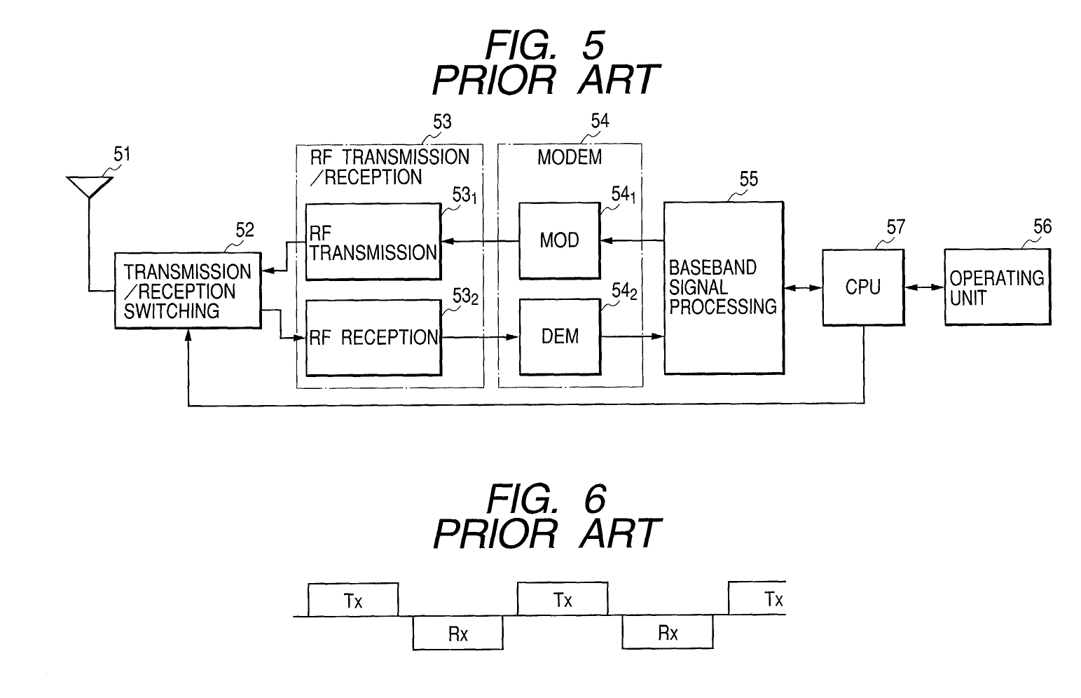

As illustrated in FIG. 1, the time division data transmitter/receiver according to the invention includes a baseband signal processing unit 1, and has the same configuration as the known time division data transmitter/receiver shown in FIG. 5 except in the baseband signal processing unit 1. In this case, the baseband signal processing unit 1 comprises a data packet formation unit 2 for forming data packets, a frame flag and retry flag setting unit 3 for setting frame flags (ff) and retry flags (rf), a memory (RAM) 4 for temporarily storing data packets, a frame flag and retry flag extraction unit 5 for extracting frame flags (ff) and retry flags (rf), and a comparator (COMP) 6 for comparing frame flags.

In the baseband signal processing unit 1, of the data packet formation unit 2, one of the output terminals is connected to the input terminal of a modulating circuit (not shown in FIG. 1) and the other output terminal is connected to the memory 4. Of the frame flag and retry flag setting unit 3, the input terminal is connected to a control unit (not shown in FIG. 1), and one of the output terminals is connected to the input terminal of the data packet formation unit 2. Of the frame flag and retry flag extraction unit 5, the input terminal is connected to the output terminal of a demodulating circuit (not shown in FIG. 1), and one of the output terminals is connected to the control unit. Of the comparator 6, a first input terminal is connected to the other output terminal of the frame flag and retry flag setting unit 3, a second input terminal is connected to the other output terminal of the frame flag and retry flag extraction unit 5, and one of the output terminals is connected to the control terminal of the data packet formation unit 2.

Now, FIG. 2 illustrates an example of format of data packets 7 used in the transmission of data by the time division data transmitter/receiver illustrated in FIG. 1.

As shown in FIG. 2, these data packets 7 have a format consisting of a preamble area 7₁ for transmitting a preamble code, an ID area 7₂ for transmitting an identification (ID) code, a frame flag area 7₃ for transmitting a one-bit frame flag, a retry flag area 7₄ for transmitting a one-bit retry flag, a data area 7₅ for transmitting data, and a cyclic redundancy check (CRC) area 7₆ for transmitting a CRC code. To add, though not shown in FIG. 2, if the data length in the data area 7₅ is variable, a data length area indicating that data length may be provided before the data area 7₅.

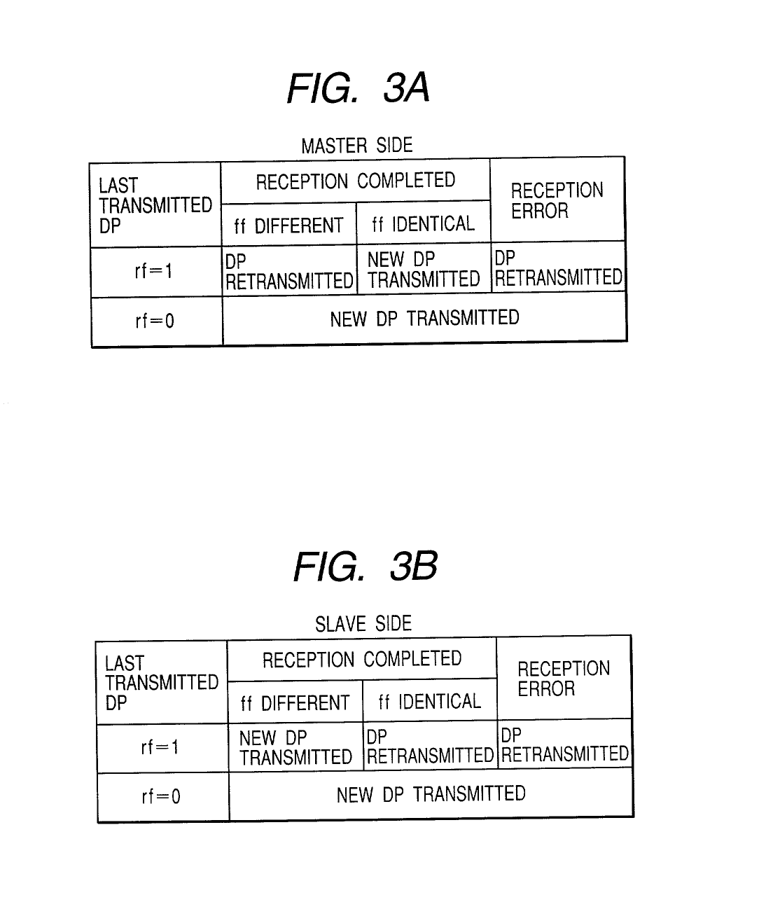

Then, FIGS. 3A and 3B are truth tables showing basic actions by the time division data transmitter/receiver illustrated in FIG. 1, wherein FIG. 3A refers to the master transmitter/receiver side, and FIG. 3B, the slave transmitter/receiver side.

In the truth tables of FIGS. 3A and 3B, reference sign DP denotes a data packet; ff, a frame flag; and rf, a retry flag.

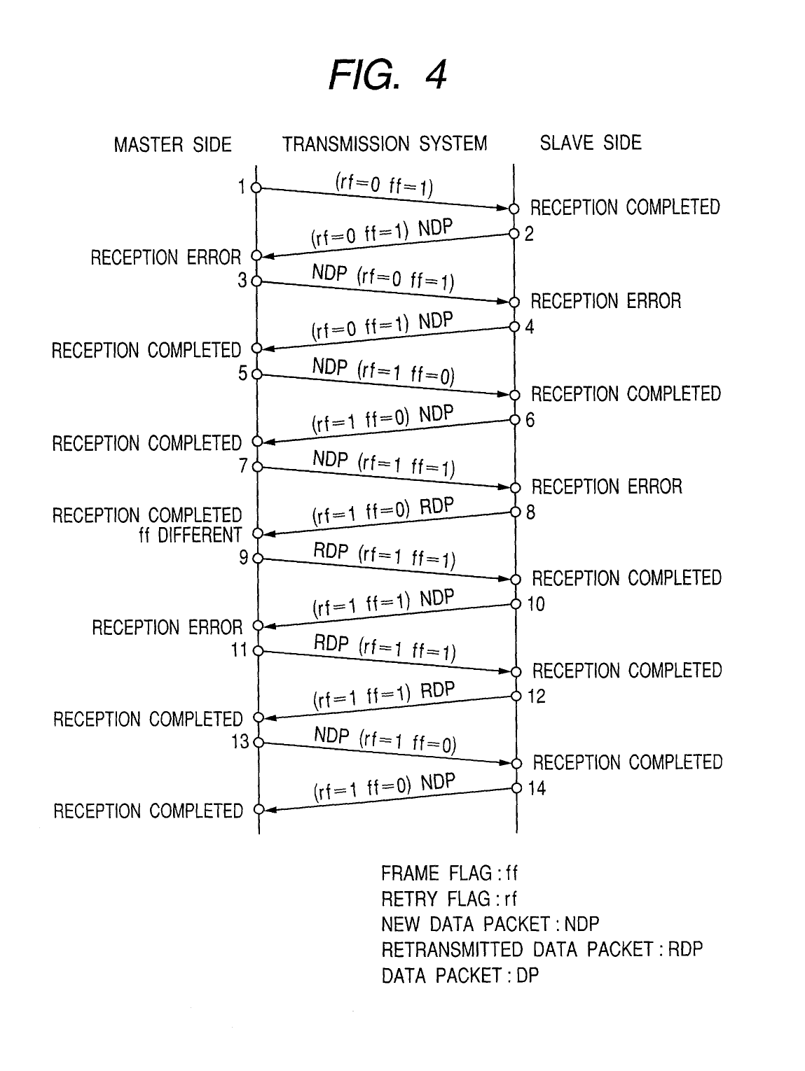

Further, FIG. 4 illustrates an example of form of data transmission/reception taking place between the time division data transmitter/receiver shown in FIG. 1 and a time division data transmitter/receiver on the other side.

In the illustration of FIG. 4, reference sign DP denotes a data packet; ff, a frame flag; rf, a retry flag, NDP, a new data packet; and RDP, a retransmitted data packet.

Hereupon, to begin with, the actions of the baseband signal processing unit 1 of the time division data transmitter/receiver configured as described above will be described with reference to FIG. 1 through FIGS. 3A and 3B. In this case, as the actions of the constituent parts except the baseband signal processing unit 1 are substantially the same as their respective counterparts illustrated in FIG. 5, their description will be dispensed with.

Before describing the actions of this baseband signal processing unit 1, the truth table on the master transmitter/receiver side shown in FIG. 3A will be explained.

In this truth table, frame flags (ff) are set so that a bit value 0 is assigned for one of two data packets to be transmitted consecutively, and a bit value 1, for the other of the data packets. Similarly in this truth table, retry flags (rf) are set so that a bit value 1 is assigned for a data packet needing retransmission, and a bit value 0, for a data packet needing no retransmission.

Where the bit value of a retry flag (rf) is 1, if the bit value of the frame flag (ff) of the just received data packet (DP) differs from that of the data packet (DP) transmitted last time in spite of the completion of reception, the last transmitted data packet (DP) is transmitted. Or if reception is completed and the bit values of the frame flags (ff) are identical, a new data packet (DP) is transmitted or, if any communication error has arisen, the last transmitted data packet (DP) is retransmitted.

On the other hand, where the bit value of the retry flag (rf) is 0, irrespective of the states of the last transmitted data packet (DP) and of the just received data packet (DP), a new data packet (DP) is transmitted.

Next, the truth table on the slave transmitter/receiver side shown in FIG. 3B will be explained.

In the slave transmitter/receiver, where the bit value of the retry flag (rf) is 1, if the bit value of the frame flag (ff) of the just received data packet (DP) is identical with that of the data packet (DP) transmitted last time in spite of the completion of reception, the last transmitted data packet (DP) is retransmitted. Or if reception is completed and the bit values of the frame flags (ff) are different, a new data packet (DP) is transmitted or, if any communication error has arisen, the last transmitted data packet (DP) is retransmitted. All other actions are the same as their respective counterparts on the master transmitter/receiver side.

Next will be described the actions of the baseband signal processing unit 1. When a transmission timing for transmit data Tx has come, in the baseband signal processing unit 1, the frame flag and retry flag setting unit 3 receives, from a control unit (not shown), transmit data, frame flag bit setting information and retry flag bit setting information, sets bit values as described above to match the supplied frame flag bit setting information and retry flag bit setting information. These frame flag and retry flag, together with transmit data, are supplied not only to the data packet formation unit 2 but also to the comparator 6. The data packet formation unit 2, using the transmit data, frame flag and retry flag so supplied, forms a data packet in which a preamble code, an ID code, a frame flag, a retry flag and a CRC code are added to the transmit data as shown in FIG. 2, and supplies the so formed data packet to a modulating circuit (not shown) as transmit data. When the bit value of the retry flag of the data packet is 1, as this data packet may be transmitted, this data packet is supplied to and temporarily stored in the memory 4. After that, as described above, this transmit data is converted by the modulating circuit (not shown) into a transmit high frequency signal, and transmitted at a transmission timing as transmit data Tx.

On the other hand, when a reception timing for receiving receive data Rx comes, receive data Rx is obtained at this point of time. This set of receive data Rx, after being amplified as described above, is demodulated by a demodulating circuit (not shown) into a baseband signal, and supplied to the frame flag and retry flag extraction unit 5 of the baseband signal processing unit 1. The frame flag and retry flag extraction unit 5 checks whether or not the supplied data packet constitutes legitimate receive data Rx, separates data from the data packet for supply to the control unit, and separates the frame flag and the retry flag for supply to the comparator 6.

The comparator 6 compares the bit values of the frame flag and the retry flag already supplied from the frame flag and retry flag setting unit 3 with the bit value of the frame flag just supplied from the frame flag and retry flag extraction unit 5. Then the comparator 6, if the bit value of the retry flag supplied from the retry flag setting unit 3 is 1, compares the bit values of the two frame flags and, if they are different, gives a retransmission instruction to the data packet formation unit 2, and the data packet formation unit 2 having received the instruction reads a data packet stored in the memory 4, supplies the data packet it has read out to a modulating circuit (not shown) as transmit data for transmission at the next transmission timing as described above.

Now will be described a specific example of a state of data transmission/reception executed between two time division data transmitter/receivers (referred to here as the master transmitter/receiver and the slave transmitter/receiver for the sake of convenience). It has to be noted, however, that in the following description the acts of transmission are assigned consecutive reference numbers according to the sequence of their execution to distinguish different data packets that are transmitted from each other, the first transmission illustrated in FIG. 4 being referred to as transmission 1, the next transmission as transmission 2 and so forth.

First in transmission 1, the master transmitter/receiver transmitted a data packet of which the frame flag (ff) was 1 and the retry flag (rf) was 0, and the slave transmitter/receiver normally received this data packet.

Then in transmission 2, the slave transmitter/receiver transmitted a new data packet (NDP) of which the frame flag (ff) was 1 and the retry flag (rf) was 0, but the master transmitter/receiver was unable to receive this data packet normally, resulting in a communication error.

Next in transmission 3, the master transmitter/receiver was unable to receive the data packet sent in transmission 2, but it ignored that data packet because its retry flag (rf) was 0, and transmitted a new data packet (NDP) of which the frame flag (ff) was 1 and the retry flag (rf) was 0. At this time, too, the slave transmitter/receiver was unable to receive this data packet normally, resulting in a communication error.

Then in transmission 4, the slave transmitter/receiver was unable to receive the data packet sent in transmission 3, but it ignored that data packet because its retry flag (rf) was 0, and transmitted a new data packet (NDP) of which the frame flag (ff) was 1 and the retry flag (rf) was 0. The master transmitter/receiver received this data packet normally.

Next in transmission 5, the master transmitter/receiver transmitted a new data packet (NDP) of which the frame flag (ff) was 0 and the retry flag (rf) was 1, and the slave transmitter/receiver received this data packet normally.

Then in transmission 6, the slave transmitter/receiver transmitted a new data packet (NDP) of which the frame flag (ff) was 0 and the retry flag (rf) was 1, and the master transmitter/receiver received this data packet normally.

Next in transmission 7, the master transmitter/receiver transmitted a new data packet (NDP) of which both the frame flag (ff) and the retry flag (rf) were 1. At this time, the slave transmitter/receiver was unable to receive this data packet normally, resulting in a communication error.

Then in transmission 8, the slave transmitter/receiver was unable to receive the data packet sent in transmission 7 and moreover, as the retry flag (rf) of that data packet was 1, it transmitted a retransmitted data packet (RDP), the same one as what was sent in transmission 6, of which the frame flag (ff) was 0 and the retry flag (rf) was 1. At this time, the master transmitter/receiver received this retransmitted data packet, but there was a difference between frame flag (ff), which was 1, of the data packet last transmitted in transmission 7 and the frame flag (ff), which was 0, of the data packet just received in transmission 8.

Next in transmission 9, the master transmitter/receiver, on account of the difference in frame flag (ff) in transmission 8, transmitted the retransmitted data packet (RDP) sent in transmission 7, of which both the frame flag (ff) and the retry flag (rf) were 1, and the slave transmitter/receiver received this data packet normally.

Then in transmission 10, the slave transmitter/receiver transmitted a new data packet (NDP) of which both the frame flag (ff) and the retry flag (rf) were 1. At this time, the master transmitter/receiver this data packet normally, resulting in a communication error.

Next in transmission 11, the master transmitter/receiver was unable to receive the packet sent in transmission 10 and moreover, as the retry flag (rf) of that data packet was 1, it transmitted a retransmitted data packet (RDP), the same one as what was sent in transmission 9, of which both the frame flag (ff) and the retry flag (rf) was 1. At this time, the slave transmitter/receiver received this retransmitted data packet normally.

Then in transmission 12, the slave transmitter/receiver, on account of the difference in frame flag (ff) in transmission 11, transmitted a retransmitted data packet (RDP), the same one as what was sent in transmission 10, of which both the frame flag (ff) and the retry flag (rf) were 1. At this time, the master transmitter/receiver received this retransmitted data packet normally.

Next in transmission 13, the master transmitter/receiver transmitted a new data packet (NDP) of which the frame flag (ff) was 0 and the retry flag (rf) was 1. At this time, the slave transmitter/receiver received this data packet normally.

Finally in transmission 14, the slave transmitter/receiver transmitted a new data packet (NDP) of which the frame flag (ff) was 0 and the retry flag (rf) was 1. At this time, the master transmitter/receiver received this data packet normally.

As hitherto described, the time division data transmitter/receiver embodying the invention in this way permits changing over of the operating mode of the baseband signal processing unit 1 according to the bit value setting of the frame flag (ff) and the retry flag (rf) as it is possible to set the bit values of the frame flag (ff) and the retry flag (rf) appropriately for each set of data. In setting the bit values of the frame flag (ff) and the retry flag (rf), setting information for the operating unit can be supplied, for instance, to the frame flag and retry flag setting unit 3 via the control unit.

What is claimed is:

1. A time division data transmitter/receiver for transmitting/receiving data packets by a time division multiple access/time division duplex communication system, having at least a transmitting/receiving unit for transmitting/receiving high frequency signals, a modulating/demodulating unit for converting the high frequency signals into baseband signals, and a baseband signal processing unit for processing the baseband signals, wherein in each of the data packets is additionally set a one-bit frame flag for specifying the data packet and a one-bit retry flag for specifying, in the event that the data packet suffers a communication error, the need or non-need to retransmit the data packet, and wherein the baseband signal processing unit is provided with a means of changing over, where the retry flag of one data packet is transmitted with the need to retransmit specified, to an operation mode to retransmit the data packet only when the frame flag specification of the data packet received immediately after that transmission is wrong or when a reception error has arisen in that received data packet.

2. The time division data transmitter/receiver according to claim 1, wherein the retry flag sets a bit value 1 when the data packet needs retransmission or a bit value 0 when the data packet needs no retransmission.

3. The time division data transmitter/receiver according to claim 1, wherein the frame flag, where two data packets needing retransmission to be transmitted consecutively are specified, specifies one of the data packets at a bit value 0 and the other data packet at a bit value 1.
